(19) United States
(12) Patent Application Publication
(10) Pub. No.: US 2026/0030103 A1
(43) Pub. Date: Jan. 29, 2026

(54) MEMORY SYSTEM AND CONTROL METHOD

(71) Applicant: Kioxia Corporation, Tokyo (JP)

(72) Inventors: Takahiro KUBOTA, Kawasaki (JP); Daiki WATANABE, Kawasaki (JP); Kosuke MORINAGA, Yokohama (JP)

(73) Assignee: Kioxia Corporation, Tokyo (JP)

(21) Appl. No.: 19/073,239

(22) Filed: Mar. 7, 2025

(30) Foreign Application Priority Data
Jul. 24, 2024 (JP) 2024-118644

(51) Int. Cl. G06F 11/10

(52) U.S. Cl. CPC G06F 11/1068; G06F 11/1004

(57) ABSTRACT

A memory controller generates Mᵢ codewords each including a parity with a size Nᵢ, divides each of the parities of the Mᵢ codewords into K partial parities, determines K×A codewords from Mᵢ codewords for Mᵢ write information and the K or less partial parities of the K×A codewords, selects partial parities from the K×A codewords, generates Mᵢ write information including the selected partial parities, and allocates continuous addresses of the nonvolatile memory to the K or less partial parities included in each of the Mᵢ write information. A number of write information with sizes of the included partial parities matched becomes larger.

### CROSS-REFERENCE TO RELATED APPLICATION

This application is based upon and claims the benefit of priority from Japanese Patent Application No. 2024-118644, filed Jul. 24, 2024, the entire contents of which are incorporated herein by reference.

### FIELD

Embodiments described herein relate generally to a memory system and a control method.

### BACKGROUND

In memory systems, in order to protect data stored in memories such as NAND flash memories, data subjected to error correction encoding is stored in memories. Therefore, when data stored in memories is read, data read from the memories and subjected to error correction encoding (also referred to as received words) is decoded to restore data before the error correction encoding.

In error correction encoding, burst errors may occur because errors are concentrative on continuous locations on storage media. Accordingly, for memory systems, diverse functions of preventing errors from being concentrated on some of codewords are proposed.

### DESCRIPTION OF THE DRAWINGS

FIG. 1 is a block diagram illustrating a memory system according to one embodiment;

FIG. 2 is a block diagram illustrating an encoding/decoding unit;

FIG. 3 is a diagram illustrating a configuration example;

FIG. 4 is a diagram illustrating examples of words to be processed;

FIG. 5 is a diagram illustrating examples of IDs of component code included in words at each cycle;

FIG. 6 is a diagram illustrating an example of a pseudocode;

FIG. 7 is a diagram illustrating the component code IDs and the number of bits included in the words at each cycle;

FIG. 8 is a diagram illustrating a situation in which burst error tolerance cannot be guaranteed;

FIG. 9 is a diagram illustrating examples of words generated in the configuration example;

FIG. 10 is a diagram illustrating other examples of the words generated in accordance with the configuration example;

FIG. 11 is a diagram illustrating examples of words to be generated;

FIG. 12 is a diagram illustrating an example of a pseudocode;

FIG. 13 is a diagram illustrating examples of words to be processed according to one embodiment;

FIG. 14 is a diagram illustrating examples of words to be processed according to one embodiment;

FIG. 15 is a diagram illustrating examples of words to be processed according to one embodiment;

FIG. 16 is a diagram illustrating a situation in which burst error tolerance cannot be guaranteed;

FIG. 17 is a diagram illustrating examples of words to be generated; and

FIG. 18 is a flowchart illustrating an example of an encoding process according to one embodiment.

### DETAILED DESCRIPTION

Embodiments provide a memory system and a control method capable of further improving tolerance to a burst error.

In general, according to one embodiment, a memory system includes a memory controller. The memory controller generates Mᵢ codewords by executing error correction coding on user data received from a host, Mᵢ being an integer equal to or greater than 2, each of the Mᵢ codewords including a parity with a size Nᵢ, Nᵢ being an integer equal to or greater than 2, i being an integer equal to or greater than 1 and equal to or less than I, I being an integer equal to or greater than 1. The memory controller divides each of the parities included in the Mᵢ codewords into K partial parities, K being an integer equal to or greater than 2, each of the K partial parities having a size common to the Mᵢ codewords. The memory controller selects K×A codewords from the Mᵢ codewords for each of Mᵢ write information, A being an integer equal to or greater than 1 or more wherein the Mᵢ write information each configured as a unit for writing a nonvolatile memory. The memory controller determines the K or less partial parities from each of the selected K×A codewords. The memory controller selects the determined K or less partial parities from the determined K×A codewords and generate the Mᵢ write information each including the selected K or less partial parities. The memory controller allocates continuous addresses of the nonvolatile memory to the K or less partial parities. The memory system includes a nonvolatile memory configured to store the Mᵢ write information based on the allocated addresses. A number of write information with sizes of the included partial parities matched becomes larger.

Hereinafter, a memory system according to one embodiment will be described in detail with reference to the appended drawings. Embodiments of the present disclosure are not limited to the following embodiments.

### 1st Embodiment

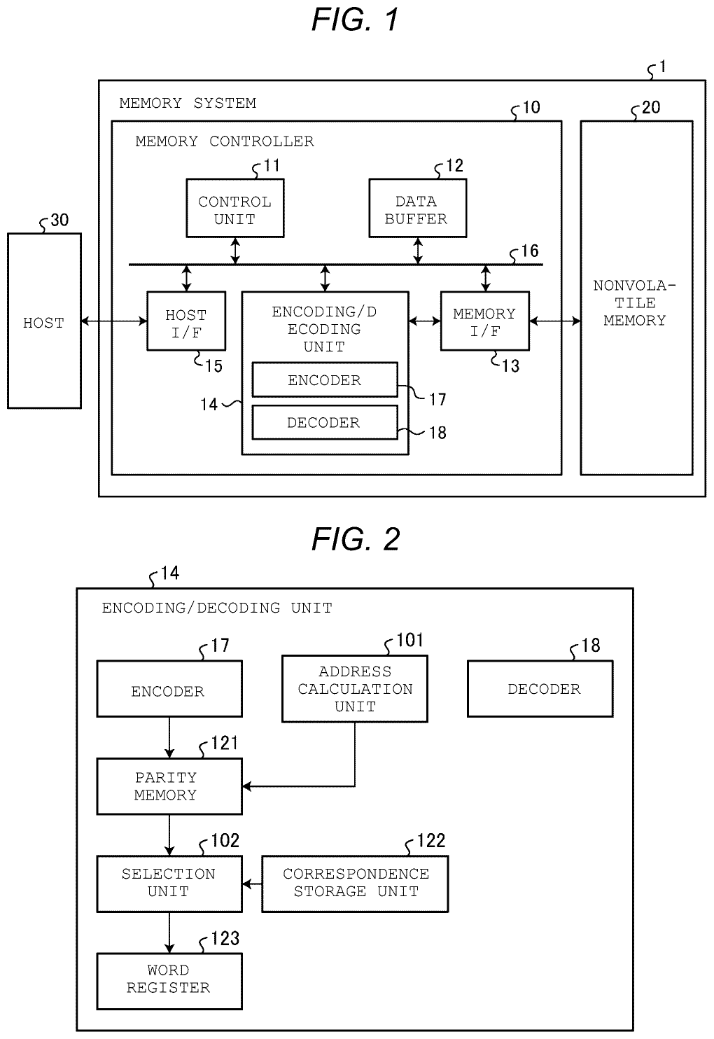

FIG. 1 is a block diagram illustrating a schematic configuration example of a memory system according to a 1st embodiment. As illustrated in FIG. 1, a memory system 1 includes a memory controller 10 and a nonvolatile memory 20. The memory system 1 can be connected to a host 30. In FIG. 1, the memory system 1 is connected to the host 30. The host 30 may be, for example, an electronic device such as a personal computer or a portable terminal.

The nonvolatile memory 20 is a nonvolatile memory that stores data in a nonvolatile manner and is, for example, a NAND memory. In the following description, a case in which the NAND memory is used as a nonvolatile memory 20 will be exemplified, but a storage device such as a 3-dimensional structure flash memory, a resistance random access memory (ReRAM), or a ferroelectric random access memory (FeRAM) other than a NAND memory can also be used as the nonvolatile memory 20. It is not essential to use a semiconductor memory as the nonvolatile memory 20 and the embodiment can also be applied to any of various storage media other than a semiconductor memory.

The memory system 1 may be a memory card or the like configured as one package including the memory controller 10 and the nonvolatile memory 20 or may be a solid state drive (SSD) or the like.

The memory controller 10 controls recording on the nonvolatile memory 20 in response to a record request from the host 30. The memory controller 10 controls reading from the nonvolatile memory 20 in response to a read request from the host 30. The memory controller 10 includes a host interface (host I/F) 15, a memory interface (memory I/F) 13, a control unit 11, an encoding/decoding unit (codec) 14, and a data buffer 12. The host I/F 15, the memory I/F 13, the control unit 11, the encoding/decoding unit 14, and the data buffer 12 are connected to each other via an internal bus 16. Some or all of operations of elements of the memory controller 10 may be implemented by causing a central processing unit (CPU) to execute firmware or may be implemented by hardware.

The host I/F 15 is a circuit that executes a process in conformity with an interface standard with the host 30 and outputs a command received from the host 30, recording target user data, and the like to the internal bus 16. The host I/F 15 transmits user data read from the nonvolatile memory 20 and restored, a response from the control unit 11, and the like to the host 30.

The memory I/F 13 is a circuit that executes a recording process on the nonvolatile memory 20 in response to an instruction of the control unit 11. The memory I/F 13 executes a read process from the nonvolatile memory 20 in response to an instruction of the control unit 11.

The control unit 11 generally controls each element of the memory system 1. When a command is received from the host 30 via the host I/F 15, the control unit 11 executes control in response to the command. For example, the control unit 11 instructs the memory I/F 13 to write user data and a parity on the nonvolatile memory 20 in response to a command from the host 30. The control unit 11 instructs the memory I/F 13 to read user data and a parity from the nonvolatile memory 20 in response to a command from the host 30.

When a request for recording the user data is received from the host 30, the control unit 11 stores the user data in the data buffer 12 and determines a storage region (memory region) in the nonvolatile memory 20 of the user data. That is, the control unit 11 manages a recording destination of the user data. A correspondence between a logical address of the user data received from the host 30 and a physical address indicating a storage region on the nonvolatile memory 20 where the user data is stored is stored as an address conversion table.

When a read request is received from the host 30, the control unit 11 converts a logical address designated with the read request into a physical address using the above-described address conversion table and instructs the memory I/F 13 to execute reading from the physical address.

In the NAND memory, generally, writing and reading are executed in units of data called a page and erasing is executed in units of data called a block. In the embodiment, a plurality of memory cells connected to the same word line are called a memory cell group. When the memory cell is a single-level cell (SLC), one memory cell group corresponds to one page. When the memory cell is a multi-level cell (MLC), one memory cell corresponds to a plurality of pages. Each memory cell is connected to a word line and also connected to a bit line. Accordingly, each memory cell can be identified with an address with which a word line is identified and an address with which a bit line is identified.

The data buffer 12 temporarily stores user data received from the host 30 by the memory controller 10 until the user data is stored in the nonvolatile memory 20. The data buffer 12 temporarily stores the user data read from the nonvolatile memory 20 until the user data is transmitted to the host 30. As the data buffer 12, for example, a general-purpose memory such as a static random access memory (SRAM) or a dynamic random access memory (DRAM) can be used.

The user data transmitted from the host 30 is transmitted to the internal bus 16 and is stored in the data buffer 12 for a moment. The encoding/decoding unit 14 encodes the user data to generate a codeword. The encoding/decoding unit 14 decodes a received word that is data read from the nonvolatile memory 20 to restore user data. Thus, the encoding/decoding unit 14 includes an encoder 17 and a decoder 18. Data encoded by the encoding/decoding unit 14 may include not only the user data but also control data or the like used in the memory controller 10.

Next, a recording process according to the embodiment will be described. The control unit 11 instructs the encoder 17 to encode the user data when the user data is recorded on the nonvolatile memory 20. At this time, the control unit 11 determines a storage location (storage address) of a codeword in the nonvolatile memory 20 and gives an instruction of the determined storage location to the memory I/F 13.

The encoder 17 encodes the user data on the data buffer 12 to generate a codeword in response to an instruction from the control unit 11. As an encoding scheme, for example, an encoding scheme such as Bose-Chaudhuri-Hocquenghem (BCH) encoding and Reed-Solomon (RS) encoding in which an algebraic code is used and an encoding scheme (a product code or the like) in which such codes are used as component codes in column and row directions can be adopted. The memory I/F 13 executes control such that a codeword is stored at a storage location on the nonvolatile memory 20 instructed from the control unit 11.

Next, a process at the time of reading from the nonvolatile memory 20 according to the embodiment will be described. The control unit 11 designates addresses on the nonvolatile memory 20 and instruction of the address to the memory I/F 13 when the addresses are read from the nonvolatile memory 20. The control unit 11 instructs the decoder 18 to start decoding. In response to an instruction of the control unit 11, the memory I/F 13 reads data from the designated address of the nonvolatile memory 20 and inputs the read data as a received word to the decoder 18. The decoder 18 decodes the received word that is data read from the nonvolatile memory 20.

Next, an error correction code (codeword) used in the embodiment will be described. In the embodiment, the encoder 17 generates a multidimensional error correction code. The error correction code to which the embodiment can be applied is not limited to the multidimensional error correction code. Here, the multidimensional error correction code is a code in which symbols that are one or more configuration units of error correction codes are protected in a multiple manner by a plurality of smaller component codes. One symbol is configured with, for example, 1-bit binary field element or an element of an alphabet such as a finite field other than a binary field. To facilitate description, an error correction code of a binary field in which one symbol is configured with one bit will be described below as an example. In the description, there may be a location where a symbol and a bit coexist, but both the symbol and the bit represent the same meaning.

As an example of a multidimensional error correction code, there is a product code. The product code has a structure in which each information symbol that is configuration units of user data is protected in each of the row and column directions with a humming code including a parity symbol with a predetermined parity length. That is, in the product code, all symbols are protected doubly by component codes in the row direction (referred to as Dimension 1) and the column direction (referred to as Dimension 2). A multidimensional error correction code is not limited thereto and may be, for example, a generalized low density parity check code (LDPC code) or the like. In a general multidimensional error correction code including a generalized LDPC code, the multiple degree of protection may differ for each symbol. The component codes cannot be grouped into dimensions such as Dimensions 1 and 2, but the present technology can also be applied to such a code configuration.

Hereinafter, for simplicity, an example in which 2-dimensional component codes (product codes) where each symbol is protected with two component codes that can be grouped into Dimensions 1 and 2 are used will be described. Each dimensional component code includes one or more component codes determined for each dimension. Hereinafter, component codes corresponding to each dimension and including one or more component codes are referred to as a component code group in some cases. For example, a component code group of Dimension 1 includes p1 component codes and a component code group of Dimension 2 includes p2 component codes. Applicable error correction codes are not limited thereto, and at least one symbol among symbols included in a code may be a P-dimensional error correction code protected by P component code groups (where P is an integer of 2 or more). When the P-dimensional error correction code is expressed by the number of component codes included in each component code group, the P-dimensional error correction code is protected by Q component codes (where Q is a total sum of pi (where 1≤i≤p), P is an integer of 2 or more, pi is the number of i-dimensional component codes).

Next, a configuration example of the encoding/decoding unit 14 that encodes and decodes a product code will be described. FIG. 2 is a block diagram illustrating an example of a detailed functional configuration of the encoding/decoding unit 14 according to the 1st embodiment. As illustrated in FIG. 2, the encoding/decoding unit 14 includes a parity memory 121, a correspondence storage unit 122, a word register 123, an address calculation unit 101, and a selection unit 102 in addition to the encoder 17 and the decoder 18.

The encoder 17 generates a codeword that is a product code by performing error correction coding on the user data received from the host. The encoder 17 generates a parity of the user data for each of a plurality of component codes included in the product code.

For example, the encoder 17 generates Mᵢ codewords (where Mᵢ is an integer of 2 or more) each including a parity with a size Nᵢ (where Nᵢ is an integer of 2 or more) for each i that is an integer of 1 or more and I or less (where I is an integer of 1 or more). In the embodiment, a case in which I is 1 will be described. That is, in the embodiment a case in which the sizes Nᵢ of the parities of a plurality of component codes are the same will be described. An example in which component codes in which I is 2 or more and parity lengths are different are used will be described in a 3rd embodiment.

Hereinafter, the size of a parity may be referred to as a parity length. M₁ (where M₁ is an integer of 2 or more) denotes a total number of the plurality of component codes with the parity length Nᵢ. The total number M₁ corresponds to the number p1 of component codes of Dimension 1 or the number p2 of component codes of Dimension 2. When the parities of Dimensions 1 and 2 are written to the nonvolatile memory 20 together, the total number M₁ may be a sum of the number p1 of component codes of Dimension 1 and the number p2 of component codes of Dimension 2.

The parity memory 121 is a memory that stores a parity for each of the plurality of component codes generated by the encoder 17. The parity memory 121 stores, for example, a parity of one component code for each address.

The address calculation unit 101 calculates an address of the parity memory 121 storing the parity of each component code.

The word register 123 is a register that stores a word. The word corresponds to write information that is a unit of writing to the nonvolatile memory 20. In the embodiment, the word is generated so that one of the plurality of partial parities obtained by dividing the parity into K partial parities (where K is an integer of 2 or more) is selected from each of the plurality of component codes and the selected partial parity is included.

The correspondence storage unit 122 stores correspondence information for generating a word. The correspondence information is, for example, information in which K×A codewords (where A is an integer of 1 or more) and one or more partial parities included in the word are determined for each of M₁ words. Hereinafter, an example in which A is 1 will be mainly described.

The selection unit 102 selects the partial parities using the correspondence information and executes a process of generating the word. For example, the selection unit 102 divides each of the parities included in M₁ codewords into K partial parities. Each of the K partial parities is a size common to the M₁ codewords.

The selection unit 102 selects K or less partial parities used to generate an xth word among the M₁ words in accordance with the correspondence information. The selection unit 102 generates the xth word so that the selected partial parities are included. After an M₁th word is generated, the process returns to the 1st word and is repeated. That is, the word in which the correspondence information is used is generated in units of M₁ words. The details of the process of generating the word using the correspondence information will be described below.

The encoding/decoding unit 14 allocates continuous addresses of the nonvolatile memory 20 to the K or less partial parities included in each of the M₁ words. The nonvolatile memory 20 stores Mᵢ words based on the allocated addresses.

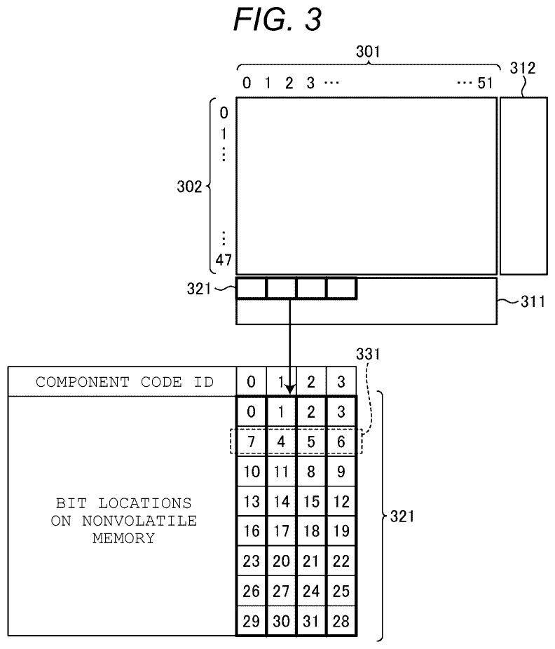

Next, an example of countermeasures against a burst error will be described. First, a configuration example E1 for the burst error countermeasures will be described. FIG. 3 is a diagram illustrating the configuration example E1.

FIG. 3 illustrates an example of a product code when the number p2 of component codes 301 in the column direction is 52 and the number p1 of component codes 302 in the row direction is 48. The component codes 301 in the column direction include a parity 311. The component codes 302 in the row direction include a parity 312. In the embodiment, targets to which burst error tolerance is given are assumed to be the parities 311 and 312. The burst error tolerance to the user data is implemented by another function.

For example, the control unit 11 can have a function of restricting occurrence of a burst error only units of bits (for example, units of 4 bits) with a specific size from the head of an address. In the embodiment, the control unit 11 is assumed to have a function of restricting occurrence of a burst error in units of 4 bits. Accordingly, countermeasures against a burst error that has a size of 4 bits, the burst error occurring in bits with addresses 4n, 4n+1, 4n+2, and 4n+3 (where n is an integer of 0 or more), will be described below.

Hereinafter, the parity 311 in the column direction will be described as an example, but the same procedure can also be applied to the parity 312 in the row direction. In the configuration example E1, a parity length of the parity of each component code is assumed to be 32 bits. The size of the word 321 of the parity 311 is similarly 32 bits. That is, the word 321 is generated so that an 8-bit partial parity selected from each of four component codes (component codes in columns 0 to 3) is included. A component code ID corresponds to, for example, a location of a column.

Addresses (bit locations) of bits included in the word 321 can be allocated so that the addresses are not continuous in the same component code. Accordingly, even when a burst error that has a 4-bit size that is the same in four component codes included in the word 321 occurs, it can be configured that an error of 2 bits or more does not occur for one component code. For example, a burst error with a length of 4 bits occurring in a bit group 331 stored at bit locations 4 to 7 is distributed bit by bit in four component codes.

The foregoing example is an example in which the number of component codes included in the word 321 and a value of a bit length of a burst error are 4 (K=4), but similar descriptions also hold true for other values.

FIG. 3 illustrates an example of the word 321 processed, for example, at a 1st cycle (hereinafter referred to as a cycle C0). A word is generated so that different component codes are selected and an 8-bit partial parity selected from each of the component codes is included. At the cycle C0, the 32-bit word 321 is stored at bit locations (addresses) 0 to 31.

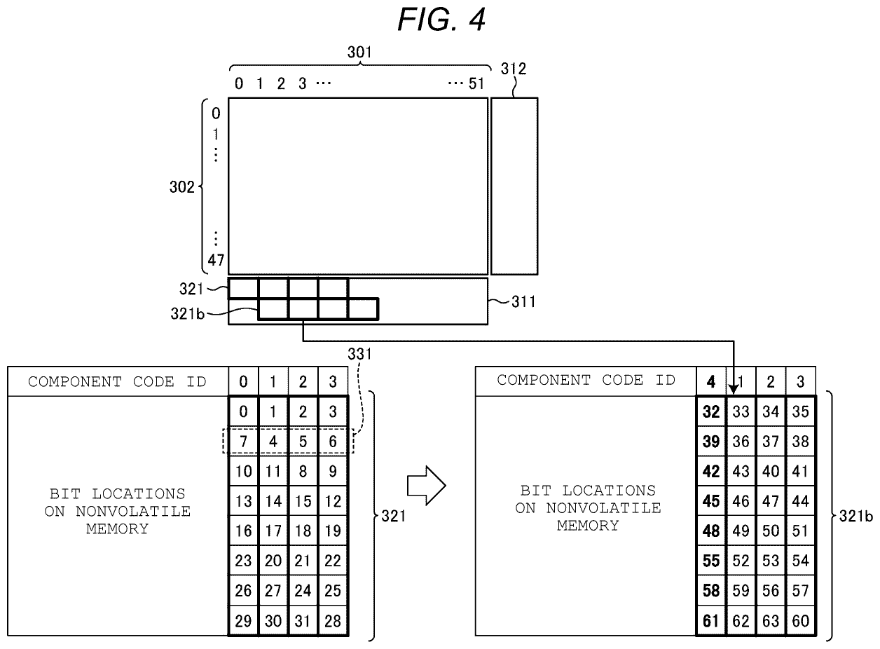

FIG. 4 is a diagram further illustrating an example of a word 321b processed at a subsequent cycle (hereinafter referred to as a cycle C1) of the cycle C0. At the cycle C1, component codes in column 4 (component codes of ID 4) are selected instead of component codes in column 0 (component codes of ID 0) selected at the cycle C0. At the cycle C1, a 32-bit word 321b is stored at bit locations (addresses) 32 to 63.

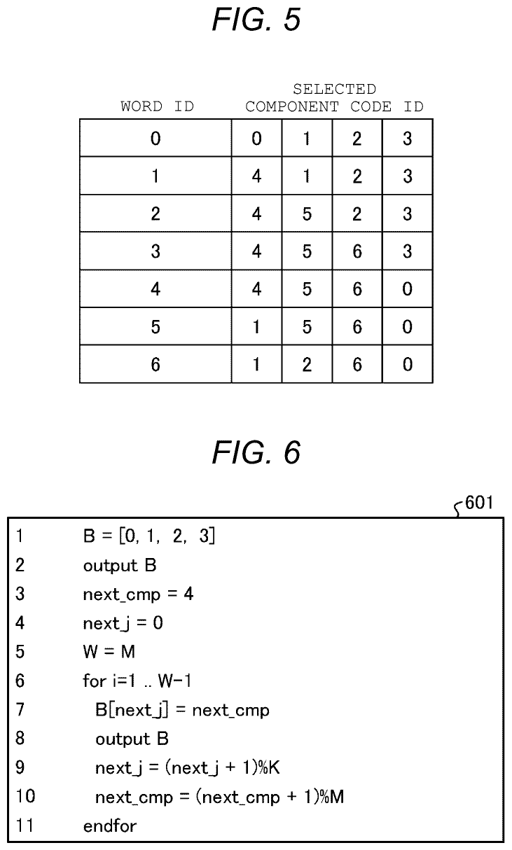

FIG. 5 is a diagram illustrating an example of IDs of component codes included in a word at each cycle. FIG. 5 illustrates examples of IDs of four component codes included in each of seven words corresponding to seven cycles. The parity of each component code is divided into four (K=4) partial parities and the four partial parities are each included in four different words. That is, any partial parity divided from the parity of each component code is output at the four cycles. In the configuration example E1, the parities of a total of 32 bits of each component code are output by 8 bits at the four cycles.

For example, since four partial parities corresponding to the component codes of ID 0 are included in words of IDs 0, 4, 5, and 6, the four partial parities are output at 0th, 4th, 5th, and 6th cycles. FIG. 5 illustrates an example in which the number of divisions is 4 (K=4), but the number of divisions may be a value other than 4.

When the number of component codes is 7, all the partial parities of seven cycles (IDs 0 to 6) are output at seven cycles as in FIG. 5. The number of component codes is not limited to 7, but may be another value. For any number of component codes, the partial parities included in each component code are all output at the same number as the number of divisions.

In the configuration example E1, a scheme (algorithm) of allocating the component codes to each word (cycle) as in FIG. 5 will be described. In the configuration example E1, a scheme of obtaining the following output (hereinafter referred to as a scheme A1-1) is applied using restrictions on the following input and output:

### Input:

the number K of component codes (in the example of FIG. 5, K=4) forming a word;
the number M of component codes (in the example of FIG. 5, M=7 and IDs 0 to 6 of the component codes); and
a parity length N (in the configuration example E1, N=32) of the component codes;

### Restrictions on Input:

N % K=0 has to be satisfied; and

### Output:

ID of a component code selected for each index j in each word (IDs of words are 0, 1, 2, . . . ).

The index j is a value indicating a location of a partial parity included in the word and takes a value of 0 to K−1 (where j=0 to 3 in the case of K=4). In the example of FIG. 5, for the word of ID 3, the indexes j and an ID of the component code correspond as follows:
j=0: ID=4 of component code;
j=1: ID=5 of component code;
j=2: ID=6 of component code; and
j=3: ID=3 of component code.

FIG. 6 is a diagram illustrating an example of a pseudocode 601 for implementing the scheme A1-1. FIG. 6 illustrates an example of the case of K=4.

B represents an ID of a component code output for each word. Since K=4, at the 1st row, an initial value of B is set with four IDs in an ascending order of values.

In the 3rd row, “next_cmp” represents an ID of a component code to be subsequently selected. At the 4th row, “next_j” represents the index j for subsequently allocating a component code. At the 5th row, “W” represents the number of words. W=M and the number of words is the number M of component codes.

At the 9th row, the index j is selected in the ascending order of values. At the 10th row, IDs of the component codes are selected in the ascending order of values. The component codes of ascending IDs 0, 1, and 2 are also selected exceptionally for the word of large IDs (4, 5, and 6 in the example of FIG. 5).

According to the scheme A1-1 illustrated in FIG. 6, the selection unit 102 sequentially selects the component codes in which the parity is output at each cycle.

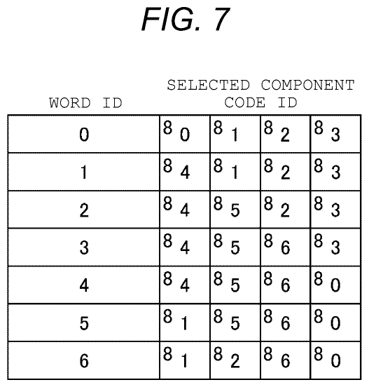

FIG. 7 is a diagram illustrating the number of bits and IDs of the component codes included in the word at each cycle. FIG. 7 corresponds to a diagram illustrating the postscript number of bits of the partial parity selected from each component code in FIG. 5. In the configuration example E1, a parity length of each component code is fixed to 32 bits and four partial parities divided from the 32-bit parity all have 8 bits. Accordingly, for all the words, the number of parities included in the word is 4 and the number of bits of each partial parity is 8 bits.

Information illustrated in FIG. 7 can be interpreted to correspond to correspondence information. That is, the information of FIG. 7 corresponds to correspondence information in which four (K=4) codewords (component codes) and one or more (in the configuration example E1, four) partial parities included in the word are determined for each of seven (M₁=7) words. The correspondence information may be obtained in advance and stored in the correspondence storage unit 122. In this case, the selection unit 102 reads the correspondence information stored in the correspondence storage unit 122 and executes a determination process of determining the partial parities included in each word using the read correspondence information. The determination process is a process of determining K×A codewords from M₁ codewords for each of M₁ words and determining K or less partial parities (in the configuration example E1, K=4) from each of the selected K×A codewords.

The selection unit 102 may generate the correspondence information in each encoding process. For example, the selection unit 102 may execute a process of generating the correspondence information earlier than the process of generating the word after a writing instruction is given from the control unit 11. In this case, the correspondence storage unit 122 may not be included.

Here, an example of a decoding process when the burst error countermeasures as in the configuration example E1 is adopted will be described.

During the decoding, the words can be obtained in an ascending order of IDs by reading data sequentially from smaller addresses (bit locations) on the nonvolatile memory 20. For example, data within the word of ID 0 is written at addresses 0 to 31 in the nonvolatile memory 20. Accordingly, the word of ID 0 is obtained by reading 32-bit data in order from address 0 of the small value.

Similarly, data in the word of ID 1 is written at addresses 32 to 61 and data in the word of ID 2 is written at addresses 62 to 95. Accordingly, the words of IDs 1 and 2 are obtained by further reading 32-bit data in order from address 0 of the small value.

By referring to the above correspondence information for each of the obtained words, it is possible to obtain the IDs of the component codes in which the bits are the partial parities for each bits that constitutes data in the word. That is, for each component code, it is possible to obtain the parity data from the data in the words. The decoder 18 executes a decoding process on each component code obtained in this way.

As described above, the configuration example E1 is an example of the burst error countermeasures when the parity length is fixed to 32 bits. Therefore, even when the configuration example E1 is applied to a parity length other than 32 bits, the burst error tolerance cannot be guaranteed in some cases.

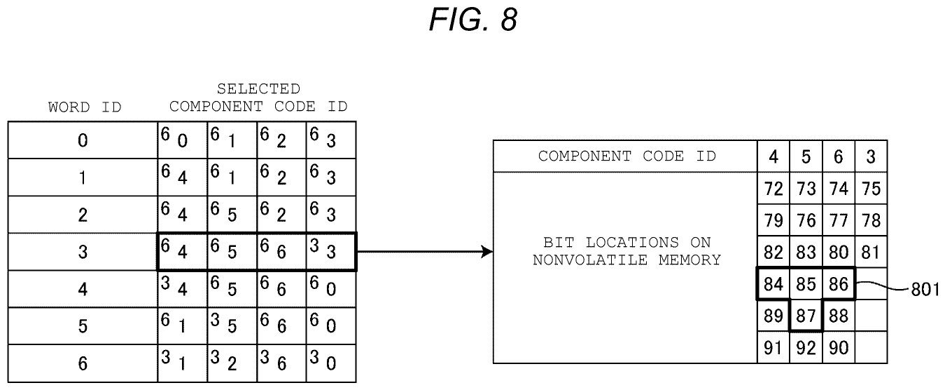

FIG. 8 is a diagram illustrating a situation in which burst error tolerance cannot be guaranteed. For example, it is assumed that the parity length of each component code is 21 bits and the number K of divisions of the parity is 4. For each component code, 21-bit parities are selected at four cycles in order of 6 bits, 6 bits, 6 bits, and 3 bits.

In this configuration, for example, in the word of ID 3, each of the partial parities of the component codes of IDs 4, 5, and 6 are 6 bits and each of the partial parities of the component code of ID 3 are 3 bits. Due to mismatch in the number of bits, a situation in which four continuous addresses (bit locations) of the nonvolatile memory 20 cannot be allocated to four component codes can occur. In an example of FIG. 8, addresses 85 and 87 are allocated to the component code of ID 5 in an address group 801 corresponding to four bits corresponding to addresses 84 to 87. Accordingly, when a burst error in units of 4 bits corresponding to addresses 84 to 87 occurs, it is not configured that an error of 2 bits or more does not occur in one component code and the burst error tolerance is not guaranteed.

Accordingly, in a configuration example E2 according to the embodiment, the configuration example E1 is improved so that the burst error tolerance is also obtained other than 32 bits of adjustment units of a parity length. For example, in the configuration example E2, an algorithm for determining bit locations is extended to correspond to a parity length other than units of 32 bits.

In the configuration example E2, the selection unit 102 executes a determination process so that the number of words in which sizes of the plurality of included partial parities match becomes larger.

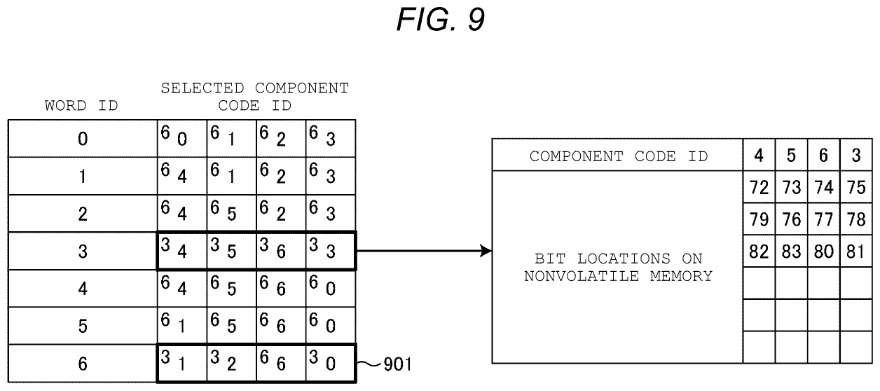

FIG. 9 is a diagram illustrating examples of words generated in the configuration example E2. FIG. 9 is a diagram illustrating the number of bits and IDs of the component codes included in the word at each cycle. In the configuration example E2, the selection unit 102 sets the parity lengths acquired from the plurality of component codes to generate the word to be the same as much as possible. To unify the sizes of the partial parities of, for example, the word of ID 3, four partial parities of component codes 4, 5, 6, and 3 have the same size (bits) in the selected order as follows:
Component code 4: 6, 6, 3, 6;
Component code 5: 6, 3, 6, 6;
Component code 6: 3, 6, 6, 6; and
Component code 3: 6, 6, 6, 3.

Bit locations on the nonvolatile memory 20 of the word of ID 3 (3rd word) are 72 to 83 (a total of 12 bits). As illustrated on the right of FIG. 9, addresses corresponding to 3 bits are allocated to four component codes. Accordingly, when a burst error of 4 bits occurs, it is configured that an error of 2 bits or more does not occur in one component code and the burst error tolerance is guaranteed.

Even in the configuration example E2, the sizes of the plurality of included partial parities do not match for some of the words in some cases. In the example of FIG. 9, in a final word 901 (the word of ID 6), the sizes of the partial parities are 3 or 6, and thus the sizes of the plurality of partial parities do not match.

In the case of “number of divisions”=“exchange period of component codes”, the configuration example E2 can also be applied to any division method and parity length. In the case of the number of component codes % “number of divisions”=0, the sizes of the plurality of partial parities included for all the words match. Accordingly, the burst error tolerance is guaranteed for all the words.

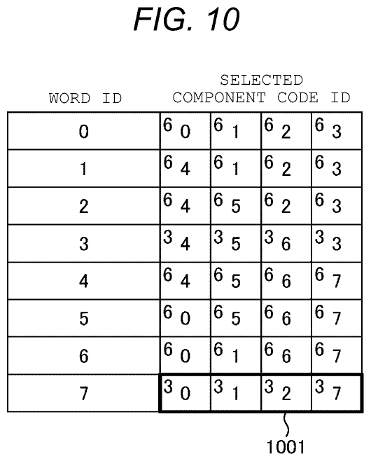

FIG. 10 is a diagram illustrating other examples of words generated in accordance with the configuration example E2. FIG. 10 illustrates an example in which the number of component codes is 8, the number of divisions is 4, and the number of component codes % “number of divisions”=0. Accordingly, for example, in a final word 1001, the sizes of the partial parities also match as 3, and thus the burst error tolerance is guaranteed.

In the case of the number of component codes % “number of divisions” ≠0, the burst error tolerance deteriorates in some words (for example, words in the vicinity of the final word). FIG. 9 illustrates an example in which the number of component codes is 7, the number of divisions is 4, and the number of component codes % “number of divisions” ≠0. Accordingly, as described above, the sizes of the plurality of partial parities in the final word 901 do not match, and thus the burst error tolerance is not guaranteed.

FIGS. 9 and 10 illustrate examples in which a 21-bit parity is divided into four partial parities of 6 bits, 6 bits, 6 bits, and 3 bits. Parity lengths of four partial parities are not limited thereto. A case in which a parity is divided into four partial parities of a bits, b bits, c bits, and d bits can be generalized.

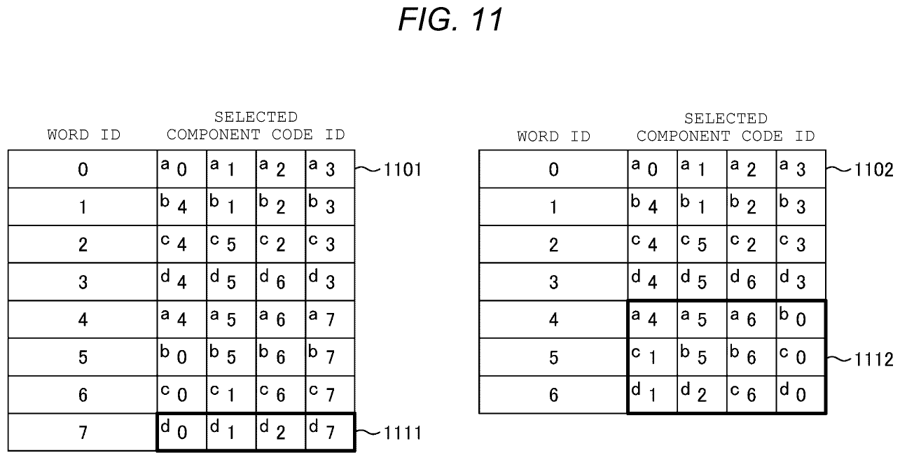

FIG. 11 is a diagram illustrating an example in which a word is generated in the generalized case. A word group 1101 on the left indicates an example of each word when the number of component codes is 8. In this case, because the number of component codes % “number of divisions”=0, the burst error tolerance is guaranteed for all the words including, for example, a final word 1111.

A word group 1102 on the right indicates an example of each word when the number of component codes is 7. In this case, because the number of component codes % “number of divisions” ≠0, for example, the parity lengths of the partial parities may not match in a word group 1112 including three words from the final word. That is, in the word group 1112, the burst error tolerance is not guaranteed in some cases. When values of a, b, c, and d match as much as possible, the number of words in which the parity lengths match can become larger.

In the embodiment, for example, the words can be generated as follows:
the sizes of the plurality of partial parities including 1st to m₁th words (where m₁ is an integer satisfying 1<m₁≤M₁) match among M₁ words.

For example, in the word group 1101 in FIG. 11, m₁=M₁=8, that is, the sizes of the partial parities match for all the 1st (ID 0) to 8th (ID 7) words. In the word group 1102, the sizes of the partial parities match for m₁=4, that is, 1st (ID 0) to 4th (ID 3) words. In 5 (=m₁+1)th to 8 (=M₁)th words, the sizes of some of the plurality of included partial parities do not match.

In the configuration example E2, a scheme (algorithm) of allocating the component codes to each word (cycle) as in FIG. 11 will be described. In the configuration example E2, a scheme of obtaining the following output (hereinafter referred to as a scheme A1-2) is applied using restrictions on the following input and output:

### Input:

the number K of component codes (in the example of FIG. 11, K=4) forming a word;
the number M of component codes;
the parity length N of the component code; and
a method of dividing the parity: n0, n1, . . . , nK−1 (in the example of FIG. 11, n0=a, n1=b, n2=c, and n3=d);

### Restrictions on Input:

$$n 0 + n 1 + … + nK - 1 = N ;$$

### Output:

Output out1: ID of a component code selected for each index j in each word (IDs of words are 0, 1, 2, . . . ); and
Output out2: parity lengths of the partial parities of the component codes selected for each index j in each word (IDs of words are 0, 1, 2, . . . ).

In the example of FIG. 11, for the word of ID 5 of the word group 1112, the indexes j and the parity lengths of the partial parities of the component code correspond as follows:
j=0: parity length=c;
j=1: parity length=b;
j=2: parity length=b; and
j=3: parity length=c.

Since a scheme of obtaining Output out1 is similar to the scheme A1-1 (for example, the pseudocode 601 of FIG. 6) of the configuration example E1, description thereof will be omitted.

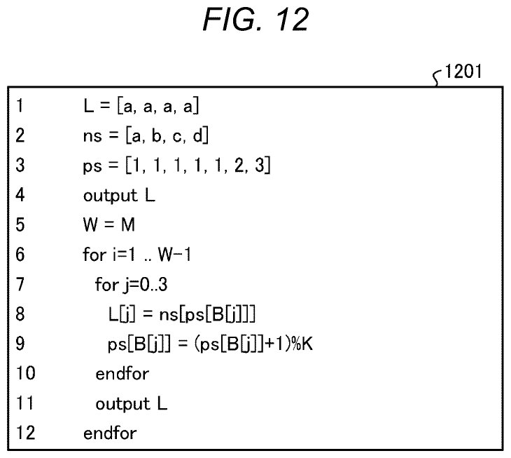

FIG. 12 is a diagram illustrating a pseudocode 1201 for implementing a process of obtaining Output out2 in the scheme A1-2. FIG. 12 illustrates an example of a case of K=4 and M (the number of component codes)=7.

L represents a parity length of a partial parity of a component code output for each word. At the 1st row, an initial value of L is set with the 1st parity length (a) for all the four component codes.

The 2nd row “ns” represents an array indicating a method of dividing a component code. For example, a parity length of each of four partial parities is set. Indexes of the array ns are assumed to be 0 to 3.

The 3rd “ps” represents an array indicating indexes of a subsequently used array ns for each component code. At the 3rd row, initial values of the array ps are set. For example, the component code of ID 6 is ps[6]=3. Therefore, for the component code of ID 6, a parity length of a subsequent partial parity is ns[3]=d.

At the 4th row, initial values [a, a, a, a] of L corresponding to the word of ID 0 are output.

At the 6th to 12th rows, L is determined for the words after ID 1 and the determined L is output. B in the 8th and 9th rows represents Output out1 (ID of a component code) obtained for the index j.

In accordance with the scheme A1-2 including the process as in FIG. 12, the selection unit 102 determines the parity lengths of the partial parities selected from the component codes.

In the scheme A1-2, as illustrated in the example (the word group 1112) of FIG. 11, one or more words from larger values of IDs can become words in which the parity lengths of the partial parities do not match. A location of the word in which the parity lengths of the partial parities do not match is not limited thereto and any location may be used.

For example, a scheme in which one or more words from smaller values of IDs are words in which the parity lengths of the partial parities do not match (hereinafter referred to as a scheme A1-2b) may be used. The scheme A1-2b may be, for example, a scheme of replacing ascending word IDs obtained in the scheme A1-2 with descending IDs.

The example in which A is 1 is described above. In a case in which A is 2 or more, one component code is substituted with a component code set including A component codes and the above procedure is applied. For example, in the case of A=4, the component code set includes four component codes. In this case, each word is generated so that a plurality of partial parities of 4×4×6 bits or 4×4×3 bits are included. Therefore, the burst error tolerance of 4×4=16 bits can be obtained.

### 2nd Embodiment

In a 2nd embodiment, for example, burst error tolerance is guaranteed for all words including a final word or the like by limiting a method of dividing a parity of a component code.

In the embodiment, a difference between sizes of K partial parities is 1 or less. For example, the selection unit 102 according to the embodiment divides a parity of a component code so that a difference between parity lengths of K partial parities is 1 or less. When K=4 and a parity length of the component codes is 21, the selection unit 102 divides the parity of the component code into three 5-bit partial parities and one 6-bit partial parity.

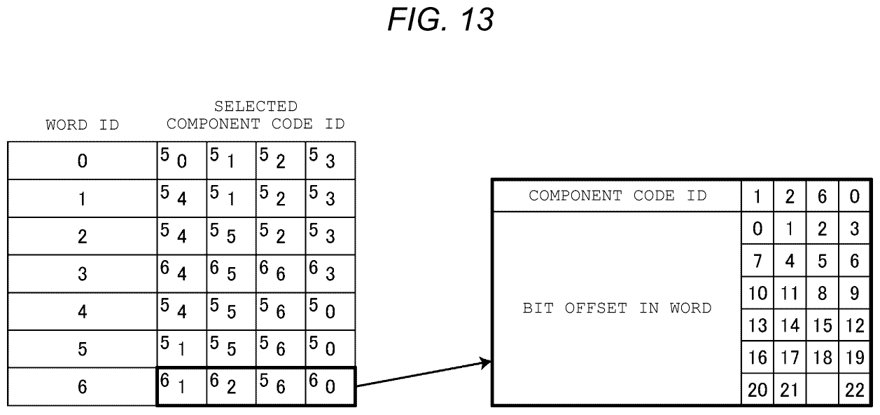

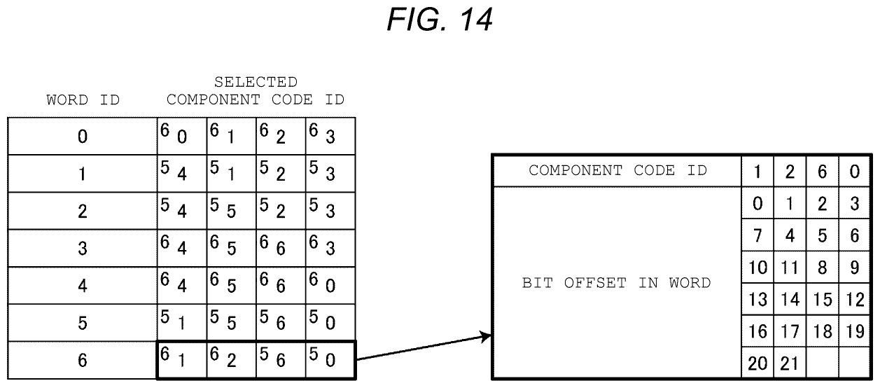

FIGS. 13 and 14 are diagrams illustrating examples of words generated in the embodiment. FIG. 13 illustrates an example of a case in which K=4, a parity length of the component codes is 21, and the number of component codes is 7. A final word (the word of ID 6) includes one 5-bit partial parity and three 6-bit partial parities. The final word is applied to 21-bit continuous addresses as illustrated on the right of FIG. 13.

FIG. 14 illustrates an example of a case in which K=4, a parity length of the component codes is 22, and the number of component codes is 7. A final word (the word of ID 6) includes two 5-bit partial parities and two 6-bit partial parities. The final word is applied to 20-bit continuous addresses as illustrated on the right of FIG. 14.

In FIGS. 13 and 14, addresses are expressed by offsets of bit locations (bit offsets) in the words.

In the embodiment, even in the final word, the difference in the number of bits is within 1. Therefore, a situation in which some of four continuous addresses (bit locations) of the nonvolatile memory 20 are allocated to the same component code does not occur. That is, it can be configured so that the burst error tolerance does not deteriorate for all the words.

### 3rd Embodiment

In a 3rd embodiment, a case in which I is 2 or more, that is, an example in which component codes in which parity lengths are different, will be described. Hereinafter, the case of I=2 will be described as an example, but a similar procedure can also be applied when I is 3 or more.

As a use case of the embodiment, for example, the following use case is assumed:
a fixed size (for example, 368 bits) is given as a parity region. The parity region is a storage region for storing a parity and is, for example, the parity memory 121. As a parity region size, a value of a multiple of 4 or a perfect power of 2 is given in some cases;
it is preferable to appropriately set the number of component codes of two types of parity lengths (for example, 21 bits and 22 bits) so that parity regions can be used as much as possible; and
burst error tolerance is given to a parity of a component code.

To correspond to the above use cases, in the embodiment, for example, the parity length and the number of component codes of the plurality of parity lengths are set as follows.

It is assumed that the parity lengths are two types of lengths of 21 bits and 22 bits, the number K of divisions of the parity is 4, and a size of a parity region is 368 bits. The parity region can be allocated to each component code so that each of the numbers of component codes of the two types of parity lengths is 4 or more. For example, in the parity region of 368 bits, a region of 21×4 bits and a region of 22×4 bits are respectively allocated to a component code of the parity length of 21 bits and a component code of the parity length of 22 bits.

The remaining parity region becomes 196 bits (=368−(21×4+22×4)). The component code of the parity length of 21 bits and the component code of the parity length of 22 bits are allocated so that the remaining parity region is used as much as possible. By setting two component codes with the parity length of 21 bits and seven component codes with the parity length of 22 bits, 196 bits can all be used.

$$196 = 21 \times 2 + 22 \times 7$$

When the parity lengths of the plurality of component codes are appropriately set (for example, a difference in the parity length is assumed to be 1), the size of a region to be used can be adjusted in units of 1 bit. Therefore, the parity region can be allocated so that the parity region is all used as long as the size of the parity region is not considerably small.

The component codes with two types of parity lengths may be any combination of component codes. For example, in the case of I=2, M₁ codewords (component codes) may be BCH codes and M₂ codewords (component codes) may be extended BCH codes. The extended BCH codes are, for example, codes in which sizes of M₁ codewords extend by adding bits indicating exclusive OR (XOR) of all bits included in the M₁ codewords.

A procedure according to the embodiment will be further described. In the case of I=2, the encoder 17 generates Mᵢ codewords each including parity of which a size is Nᵢ for each of i=1 and i=2. Hereinafter, an example of N₁=21, M₁=7, and N₂=22 will be mainly described. N₁, M₁, and N₂ are not limited to these values. The value of M₂ is not particularly limited, and may be 7 that is the same value as M₁ or may be a value different from M₁.

In the embodiment, the correspondence storage unit 122 stores two pieces of correspondence information corresponding to i=1 and i=2. Each piece of correspondence information is information in which K×A codewords and one or more partial parities included in a word are determined for each of Mᵢ words.

In the embodiment, the selection unit 102 divides each of the parities included in Mᵢ codewords into K partial parities for each of i=1 and i=2. Each of the K partial parities is a size common to Mᵢ codewords. The selection unit 102 selects K or less partial words used to generate an xth word among the Mᵢ words in accordance with the correspondence information. The selection unit 102 generates the xth word so that the selected partial parities are included.

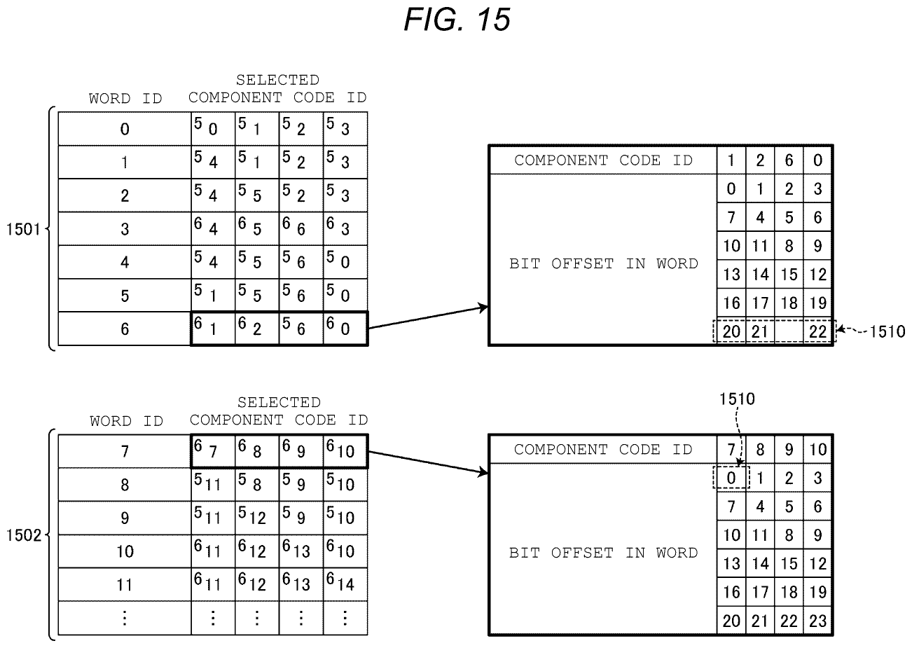

In this way, in the embodiment, the word is generated for each i in the procedure of the 1st or 2nd embodiment. FIG. 15 is a diagram illustrating examples of words generated in the embodiment. A word group 1501 and a word group 1502 indicate examples of words corresponding to i=1 and i=2, respectively.

The word group 1501 includes words generated by applying the procedure of the 2nd embodiment to component codes with a parity length of 21 bits. The word group 1502 includes words generated by applying the procedure of the 2nd embodiment to component codes with a parity length of 22 bits.

In the example of FIG. 15, after the word group 1501 including words of IDs 0 to 6 are generated, the word group 1502 including words of ID 7 and subsequent IDs is generated. The procedure of the parity lengths of the component codes used to generate the word group may be any procedure. For example, after the word group for component codes with the parity length of 22 bits is generated, the word group for component codes with the parity length of 21 bits may be generated. A word group for component codes with the same parity length may be continuously generated.

In the example of FIG. 15, a burst error occurring in a final word (the word of ID 6) of the word group 1501 is inserted into a component code of ID 7 included in a 1st word (the word of ID 7) of the subsequent word group 1502. That is, 4-bit burst errors 1510 are all distributed in other component codes.

In FIG. 15, for the word groups 1501 and 1502, the above scheme A1-2, that is, a scheme in which the parity lengths of the partial parities do not match in one or more words from the larger value of IDs, is applied. In this application method, burst error tolerance cannot be guaranteed for a subsequent word group.

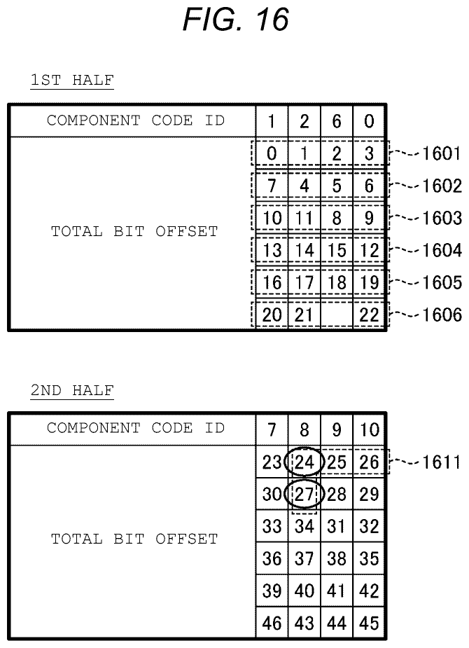

An example of a situation in which the burst error tolerance cannot be guaranteed will be described with reference to FIG. 16. The 4-bit burst error starts from a location at which a remainder obtained by dividing a total of bit offset by 4 is 0. The accumulated bit offset indicates a bit offset totaled from the 1st word (the word of ID 0).

A 1st half of FIG. 16 corresponds to, for example, a component code and a bit offset determined for the word of ID 6 of the word group 1501 of FIG. 15. In FIG. 16, to facilitate description, bit offsets totaled from the word of ID 6 are recorded.

In the 1st half, the 4-bit burst error starts from locations of bit offsets 0, 4, 8, 12, 16, and 20. Burst errors 1601 to 1606 indicate burst errors in the case of start from each of the start locations. In the 1st half, the burst errors are equally distributed to a plurality of different component codes.

The 2nd half corresponds to, for example, a component code and a bit offset determined for the word of ID 7 of the word group 1502 of FIG. 15. In the 2nd half, burst error tolerance cannot be obtained in some cases due to an influence of a row including a bit in which there is no data of the 1st half.

In the example of the 2nd half in FIG. 16, the 4-bit burst error starts from locations of bit offsets 24, 28, 32, . . . . Therefore, for example, 2-bit errors corresponding to the bit offsets 24 and 27 among the 4-bit burst errors 1611 starting from the bit offset 24 are distributed to component codes of ID 8. In this way, the distribution of the burst errors to the component codes becomes inequal and the burst error tolerance cannot be guaranteed in some cases.

To avoid such a situation, the scheme applied during generation of continuous word groups may be changed. For example, an application method in which the above scheme A1-2 is applied to the first generated word group (hereinafter also referred to as the 1st half) and the above scheme A1-2b is appropriate for a subsequently generated word group (hereafter also referred to as the 2nd half) may be used.

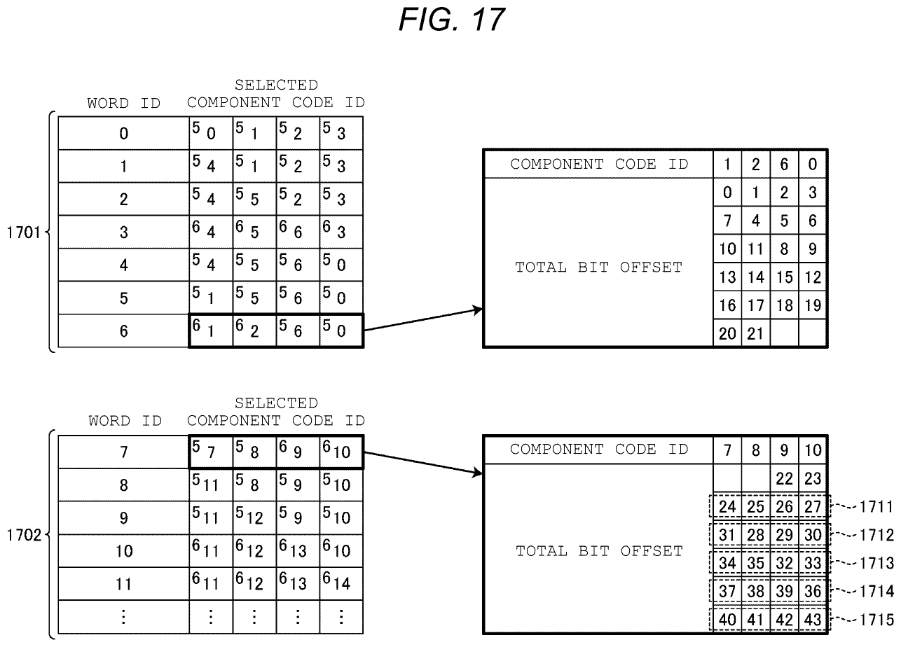

FIG. 17 is a diagram illustrating examples of words generated when this application method is used. A word group 1701 and a word group 1702 include words generated by applying the scheme A1-2 to the component codes with the parity length of 22 bits. According to the application method, it can be configured that burst errors 1711 to 1715 are also equally distributed to a plurality of different component codes in the 2nd half.

The application method of FIG. 17 corresponds to the following method of generating words:
I is 2;
the sizes of the plurality of partial parities including 1st to m₁th words (where m₁ is an integer satisfying 1<m₁<M₁) match among M₁ words (in the example of FIG. 17, m₁=6);
in m₁+1th to M₁th words among M₁ words, sizes of at least some of the plurality of included partial parities do not match;
in 1st to m₂th words (where m₂ is an integer satisfying 1<m₂≤M₂) among M₂ words, sizes of at least some of the plurality of included partial parities do not match (in the example of FIG. 17, m₂=1); and
in m₂+1th to M₂th words among M₂ words, sizes of the plurality of included partial parities match.

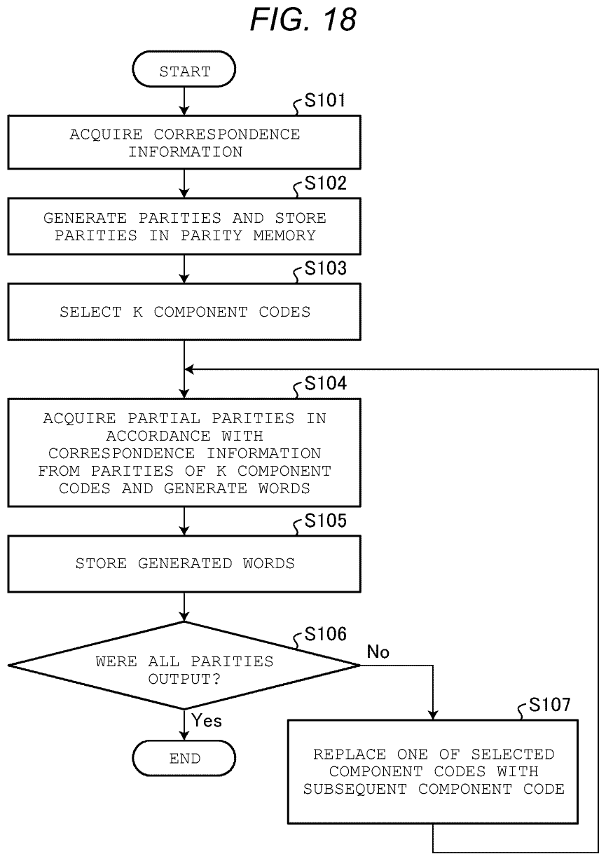

Next, a flow of an encoding process by the memory system 1 according to the embodiment will be described. FIG. 18 is a flowchart illustrating an example of an encoding process according to the embodiment.

When an instruction to encode the user data is given from the control unit 11, the encoder 17 acquires the correspondence information from, for example, the correspondence storage unit 122 (step S101). The encoder 17 generates the parities of the user data in the parity memory 121 (step S102).

The selection unit 102 selects K component codes corresponding to an initial value (step S103). This process corresponds to, for example, a 1st row of the pseudocode 601.

The selection unit 102 acquires partial parities in accordance with the correspondence information from the parities of the selected K component codes and generates words including the acquired partial parities (step S104). The selection unit 102 stores the generated words in the word register 123 (step S105). The words stored in the word register 123 are stored in addresses in which subsequent words are further written to the nonvolatile memory 20.

The encoder 17 determines whether the parities are all output (step S106). When the parities are all not output (No in step S106), the selection unit 102 substitutes one of the selected component codes with a subsequent component code in accordance with the correspondence information (step S107) and returns to step S104 to repeat the process.

When the parities are all output (Yes in step S106), the encoder 17 ends the encoding process.

As described above, according to the embodiments, the burst error tolerance can be obtained for the parities other than 32 bits of adjustment units with a parity length. That is, it is possible to further improve tolerance to a burst error.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A memory system comprising:
a memory controller configured to:
generate Mᵢ codewords by executing error correction coding on data received from a host, Mᵢ being an integer equal to or greater than 2, each of the Mᵢ codewords including a parity with a size Nᵢ, Nᵢ being an integer equal to or greater than 2, for each i being an integer equal to or greater than 1 and equal to or less than I, I being an integer equal to or greater than 1,
divide each of the parities included in the Mᵢ codewords into K partial parities, K being an integer equal to or greater than 2, each of the K partial parities having a size common to the Mᵢ codewords;
select K×A codewords from the Mᵢ codewords for each of Mᵢ write information, A being an integer equal to or greater than 1 or more wherein the Mᵢ write information each configured as a unit for writing a nonvolatile memory;
determine the K or less partial parities from each of the selected K×A codewords;
select the determined K or less partial parities from the determined K×A codewords and generate the Mᵢ write information each including the selected K or less partial parities; and
allocate continuous addresses of the nonvolatile memory to the K or less partial parities; and
a nonvolatile memory configured to store the Mᵢ write information based on the allocated addresses,
wherein a number of write information with sizes of the included partial parities matched becomes larger.

2. The memory system according to claim 1, wherein a difference between the respective sizes of the K partial parities is equal to or less than 1.

3. The memory system according to claim 1, wherein the Mᵢ codewords are components of a product code.

4. The memory system according to claim 1,
wherein I is equal to 2,
wherein the M₁ codewords are Bose-Chaudhuri-Hocquenghem (BCH) codes, and
wherein the M₂ codewords are extended BCH codes.

5. The memory system according to claim 1,
wherein I is 1, and
wherein sizes of the included partial parities match in 1st to m₁th of the M₁ write information, m₁ being an integer satisfying 1<m₁≤M₁.

6. The memory system according to claim 1,
wherein I is 2,
wherein sizes of the included partial parities match in 1st to m₁th of the M₁ write information, m₁ being an integer satisfying 1<m₁<M₁, and sizes of at least some of the included partial parities do not match in m₁₊1th to M₁th of the M₁ write information, and
wherein sizes of at least some of the included write information among the M₂ write information do not match in 1st to m₂th write information, m₂ being an integer satisfying 1≤m₂<M₂, and sizes of the included partial parities match in m₂+1th to M₂th write information.

7. The memory system according to claim 1, wherein the memory controller executes the determination process using correspondence information in which the K×A codewords and one or more of the partial parities included in the write information are used for each of the Mᵢ write information.

8. A control method of controlling a nonvolatile memory, the method comprising:
generating Mᵢ codewords by executing error correction coding on user data received from a host, Mᵢ being an integer equal to or greater than 2, each of the Mᵢ codewords including a parity with a size Nᵢ, Nᵢ being equal to or greater than 2 for each i that is an integer being equal to or greater than 1 and equal to or less than I, I being an integer equal to or greater than 1;
dividing each of the parities included in the Mᵢ codewords into K partial parities, K being an integer equal to or greater than 2, the K partial parities having a common size;
selecting K×A codewords from the Mᵢ codewords for each of Mᵢ write information, A being an integer equal to or greater than 1, the Mᵢ write information being a unit for writing the nonvolatile memory;
determining the K or less partial parities from each of the selected K×A codewords;
selecting the determined K or less partial parities from the determined K×A codewords;
generating the Mᵢ write information each including the selected K or less parities;
allocating continuous addresses of the nonvolatile memory to the K or less partial parities included in each of the Mᵢ write information; and
storing the Mᵢ write information based on the allocated addresses in the nonvolatile memory,
wherein a number of write information with sizes of the included partial parities match becomes larger.

9. The memory system according to claim 1, wherein the nonvolatile memory includes a NAND memory.

10. The memory system according to claim 1, wherein the nonvolatile memory includes a 3-dimensional structure flash memory, a resistance random access memory (ReRAM), or a ferroelectric random access memory (FeRAM).

11. The memory system according to claim 1, wherein the Mᵢ codewords are generated based on a low density parity check code.

12. The memory system according to claim 1, wherein the Mᵢ codewords are generated based on at least one of a Bose-Chaudhuri-Hocquenghem (BCH) encoding or a Reed-Solomon (RS) encoding.

13. The control method according to claim 8, wherein the nonvolatile memory includes a NAND memory.

14. The control method according to claim 8, wherein the nonvolatile memory includes a 3-dimensional structure flash memory, a resistance random access memory (ReRAM), or a ferroelectric random access memory (FeRAM).
